(19) United States
(12) Patent Application Publication
(10) Pub. No.: US 2005/0004915 A1
(43) Pub. Date: Jan. 6, 2005

(54) METHOD FOR GENERATING NAMES

(76) Inventor: Jean-Philippe Hermand, Paris (FR)

Correspondence Address: ROTHWELL, FIGG, ERNST & MANBECK, P.C., 1425 K STREET, N.W., SUITE 800, WASHINGTON, DC, 20005, US

(21) Appl. No.: 10/442,263

(22) Filed: May 21, 2003

(51) Int. Cl. G06F 7/00

(52) U.S. Cl. 707/10

(57) ABSTRACT

A method generates names that are different from those comprised in a set of existing names. A set of patterns is provided and one of the patterns of the set is selected. The pattern is then actualized to provide a list of candidate names. The list of candidate names is then filtered against the set of existing names to provide names, which are different from those comprised in the set of existing names. The method makes it possible to generate domain names, uniform resource locators, trademarks or the like.

### FIELD OF THE INVENTION

The invention relates to the field of naming and notably applies to domain names, trademarks, company names or the like.

### BACKGROUND OF THE INVENTION

In various fields, there is a need for generating names or denominations that are distinct from existing ones. This need is felt for Internet domain names and uniform resource locators (URLs), which have to be different from those already registered. The same need arises for trademarks and tradenames; trademarks should be different from existing trademarks or trademark applications, taking into account the products for which the trademark is registered or the trademark application is granted. The same need further arises from company names.

U.S. Pat. No. 6,298,341 discloses a system and method for generating domain names and for facilitating registration and transfer of the same. The user inputs to the system one or more root terms. The root term inputted by the user is concatenated in any way to predetermined terms found in a database, such as leading and trailing terms. The resulting candidate names are then checked for availability in a domain name system lookup or by carrying a WHOIS type or similar query. Available candidate domain names are then proposed to the user for selection and registration of a domain name. The solution proposed in this document only provides a limited number of possible domain names and is intrinsically limited to concatenated terms.

In the field of trademarks, creation of names is usually a manual process. Candidate names are checked for availability by conducting a trademark search among existing trademarks. If the candidate name is found to be similar to an existing trademark, the process is repeated. Also, candidates that are similar to an existing trademark are also eliminated. The process is long and costly. The same process applies to company names.

### SUMMARY OF THE INVENTION

Accordingly, there is a need for a method for generating names or denominations, which are different from names comprised in a set of existing names.

In one embodiment of the invention, there is provided a computer-implemented method for generating names, comprising the steps of
storing a set of patterns, each pattern comprising names having a common feature;
providing a set of existing names;
selecting one pattern of the set of patterns;
actualizing the selected pattern to provide a list of possible names; and
filtering the list of possible names against the set of existing names.

In this embodiment, the step of actualizing may comprise providing a dictionary and extracting names out of the dictionary, according to the selected pattern. This step could also comprise extracting names out of the set of names and amending the extracted names; such amendment may be carried out by changing at least one letter of an extracted name.

The step of selecting one pattern may be carried out by a user. It is also possible to provide at least two names; determine a feature common to said at least two names; and determine a selected pattern in the set comprising names having said determined feature.

For the step of filtering, one may delete from the list of possible names names comprised in the set. One may also or alternatively delete from the list of possible names names similar to those comprised in the set of names.

In another embodiment, the invention provides a computer-implemented method for generating names, comprising the steps of
storing a set of patterns, each pattern comprising names having a common feature;
providing a set of existing names partitioned into classes;
selecting one class in the set of existing names;
selecting one pattern of the set of patterns;
actualizing the selected pattern to provide a list of possible names;
the step of actualizing comprising searching for names having the common feature of the selected pattern among the names contained in the set of existing names and not belonging to the selected class.

The list of possible names may then be filtered. This step of filtering may consist in deleting from the list of possible names names similar to those comprised in the selected class.

The selection of one or more pattern may be carried out as discussed in the first embodiment.

The invention also provides a computer program, comprising
a database of patterns, each pattern comprising names having a common feature;
a database of existing names partitioned into classes;
a routine for allowing a user to select one class in the set of existing names;
a routine for allowing a user to select one pattern of the set of patterns;
a routine for actualizing the selected pattern to provide a list of possible names;
the routine for actualizing comprising a routine for searching for names having the common feature of the selected pattern among the names contained in the set of existing names and not belonging to the selected class.

The program may also comprise a routine for filtering the list of possible names. This routine may filter the list of possible names by deleting from the list of possible names names similar to those comprised in the selected class.

A method embodying the invention will now be described, by way of non-limiting example, and in reference to the accompanying drawings, where:

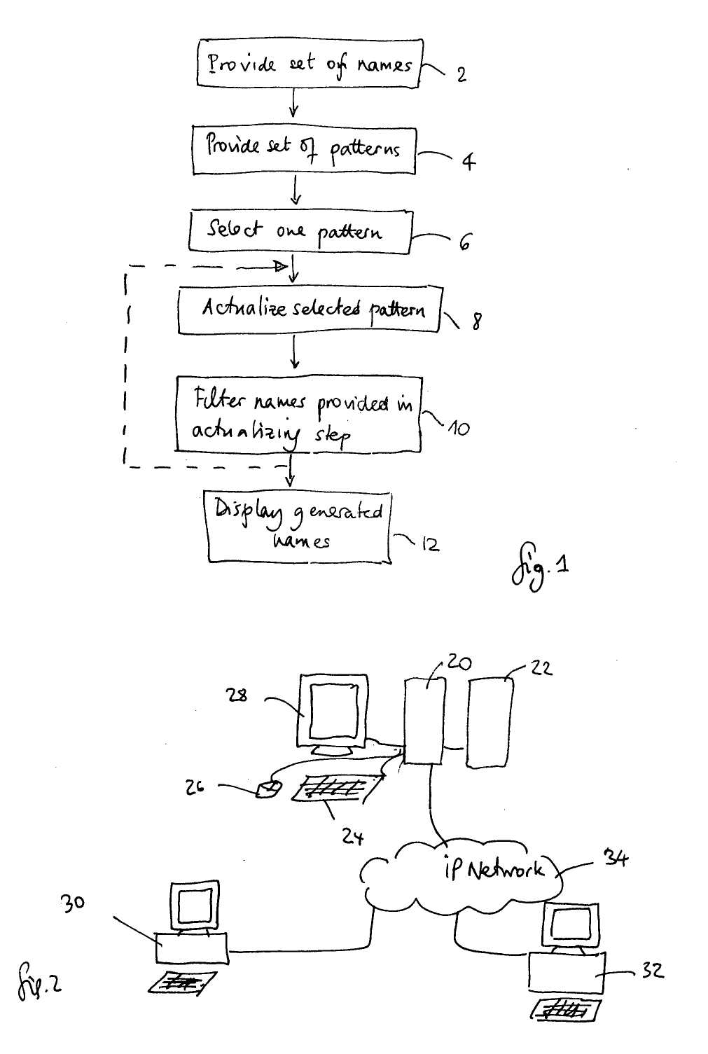

FIG. 1 is a flowchart of the method;

FIG. 2 is a schematic view of a computer system embodying the invention.

### BEST MODE OF CARRYING OUT THE INVENTION

The invention proposes a computer-implemented method for generating names, which are different from the names comprised in a set of existing names. The word “names” as used in the present specification covers various types of names and denominations. The method could thus be used for generating domain names or URLs, different from domain names or URLs already registered; in this example, names would be domain names or URLs. The method could be used for generating trademarks, which are different from already registered trademarks or pending trademark applications; in this example, names would be trademarks. The method could be used for generating company names, which are different from already existing company names; in this example, names would be company names. The method could also be used for generating names different from those contained in a telephone directory or the like. In the rest of this specification, the invention is exemplified on trademarks, it being understood that the invention also applies to other types of names.

The method is based on the use of patterns. A pattern is a set of names having a common feature; the pattern is usually associated with an identifier, which is used for designating the pattern. It is a usual abuse of language to designate the identifier as the pattern. For instance, one possible pattern is comprised of botany names, that is, names used in botany, such as names of plants, trees etc. The pattern identifier could be “botany”, which is at the same time the pattern identifier and the common feature of the names comprised in the pattern.

This common feature may be semantic, formal, phonetic or composite. A name may be comprised in several patterns. Possible patterns are provided, by way of example. The patterns in the following set have a semantic common features; the definition of the pattern is provided, except where it is fully apparent from the designation of the pattern:
lexemes in a given language;
botany; the pattern is comprised of names used in botany, such as names of plants and trees;
colours;
astronomy; gems, animals, gods, winds;
fixed syntagms; the pattern is comprised of syntagms which exist as such in a given language. For instance “no smoking” or “traffic lights” are fixed syntagms of the English language;
toponyms; the pattern is comprised of place names;
true friends; the pattern is comprised of lexemes having the same meaning in various languages;

The patterns in the following set have formal common feature:
shorts words; the pattern is comprised of names having a length shorter than a given number of letters;
palindromes; the pattern is comprised of names that may indifferently be read from left to right or from right to left;
partially symmetric names; the pattern is comprised of names which are palindromes, except for one or two letters; for instance, ALLIA is a name which is almost a palindrome;
names with repeated syllables;
names with a given number of syllables.

Phonetic patterns are free syntagms or logatomes, that is sequences of letters that may be pronounced, but are not comprised in semantic patterns. Such phonetic patterns may be classified by common letter:
logatoms starting with a given set of letters; for instance, the VIV-pattern comprises all names starting with the letters VIV;
logatoms ending with a given set of letters; for instance, the -TAX pattern comprises all names ending with the letters TAX.
logatoms comprising a given set of letters.
   Free syntagms are comprised of several lexems, built on the basis of admitted grammar rules in a given language. For instance, “flower for you” is an example of free syntagm in the English language;

These are only examples of patterns; patterns may also be composite. Following are examples of composite patterns:
oxymorons; the pattern comprises sets of two lexemes in contradictory registers, such as CLEAR OBSCURITY or DARK LIGHT;
alphanumerical allographs, like U.2 (“you too”) or T.4.2 (“tea for two”);
derivates; the pattern is comprised of names derived from a given name, by changing one or several letters;
palindromic lexemes, like ROTOR;
neologisms, which are words derived from an existing lexeme.

One may use definitions of patterns other than those provided above.

FIG. 1 is a flowchart of a method embodying the invention. In step 2, there is provided a set of existing names. The set may comprise existing trademarks, e.g. retrieved from trademark databases. The process then passes to step 4

In step 4, there is provided a set of patterns. The set of patterns comprises at least two different patterns, but preferably comprises a number of pattern. One could for instance use the various patterns provided above. After step 4, the process passes to step 6

In step 6, one pattern among the set of patterns is selected. The various methods for selecting one of the patterns are discussed below in reference to FIG. 2. It is sufficient to say that selection of a pattern does not require that the user of the method creates a name—although this may be one solution for identifying a pattern. After step 6, a selected pattern is provided and the process passes to step 8.

In step 8, the pattern is actualized. This provides a list of names that belong to the pattern. The way the actualization step may be carried out depends on the selected pattern. For the various patterns discussed above, there is provided some indication of a possible way to carry out the actualization step. Generally speaking, one solution for actualizing a semantic pattern consists in using a dictionary related to this pattern
lexemes in a given language: the actualization step is carried out by sampling the entries of a dictionary of lexemes in the given language;
botany, colours, astronomy, gems, gods, winds: the actualization step is carried out by sampling the entries of a relevant dictionary;
fixed syntagms: the actualization step is carried out by sampling the entries of a dictionary having more than two words; one may also use a dictionary of fixed syntagms;
true friends: the actualization step may comprise comparing the entries of dictionaries in various languages, and selecting common entries;
toponyms: the pattern is actualized based on the index of an atlas.

Formal patterns may be actualized using one or several dictionaries and filtering rules. For instance, short words may be extracted from dictionaries; the same applies to palindromes, even though one could use a dictionary of palindromes. Changing one or two letters in palindromes is a solution for actualizing a pattern of partially symmetric names.

Similar solutions may apply to phonetic patterns. One may parse a dictionary. One may also change the first or last letters of entries of a dictionary into a given set of letters. These solutions are far more efficient that the simple concatenation provided in the prior art. Names with doubled syllables may be filtered from a dictionary. They could also be generated by doubling one syllable in existing names or lexemes.

Composite patterns may also be actualized on the same basis. Oxymorons could be created with a thesaurus; one could start from an existing oxymoron and change each of its terms into its synonyms. One may also sample the synonyms of two given antonyms. Changing one or several letters of existing lexemes provides a number of neologisms.

Generally speaking, patterns which are not semantic may be actualized using toponyms. A dictionary of toponyms provides a number of logatoms issued from various phonologic systems. These toponyms may be filtered or adapted by changing one or several letters, doubling syllables, or applying one of the processes disclosed above.

Another solution for actualizing a pattern is to use an antibase of existing names. This assumes the set of existing names is partitioned in several classes and that the names to be generated should belong to one given class of the set. One assumes here that the partition is such that the set of existing names is covered by the various classes—if necessary, using a “bin” class for remaining names; the classes may overlap—for instance, if a given name belongs to several classes. Under these assumptions, names which do not belong to the given class but only to other classes are potential candidates and may be used for actualizing a pattern. In the example of URLs, the set of existing names is partitioned in classes defined by the top level domain indicator. The antibase for generating names in a given top level domain (e.g. “.org”) could be formed of all the cipher or root name of all URLs which do not belong to the “.org” top level domain, completed with the given top level domain.

In the example of trademarks, the set of existing names is partitioned in classes defined by the classes of goods and services. The antibase for generating names in a given class is formed of trademarks in all other classes. One may take into account countries where the trademarks are registered for providing another antibase. Both solution may be mixed.

In the example of company names, the set of existing names is partitioned in classes, defined, e.g. by the country in which the companies are registered, or by the activity of the companies. The antibase for generating company names for a given country, respectively activity, could be formed of company names existing in other countries, respectively activities.

The antibase provides a reservoir of possible names, which may thereafter be filtered or processed. These names have the advantage of being conformist, that is comply with existing standards of selection of names. The antibase actualizing method is discussed above in reference to one class only. One may also apply the method with more than one class. In the example of trademarks, one could intend to generate trademarks in two classes; the trademarks in the remaining classes would then provide the antibase. This applies to more than two classes.

Last, actualizing may also comprise using a thesaurus or using analogy. For instance, a search for names relating to football could comprise filtering the antibase or the set of existing names for all names comprising “basket” or “hockey” and then substituting “football” to “basket” or “hockey” in the filtered names. These various examples of actualizing solutions may be classified as follows. The various examples of actualization based on a dictionary or an index are exogen actualizations. The actualization is based on the dictionary or index; one may provide in this step of actualization an additional filtering step. In other words, one need not actualize the pattern with all the names present in the dictionary or in the index; actualization may be limited to a subset of these names—e.g. names with a given number of letters or syllables, names starting or ending with a given letter or set of letters, etc. One may also decide to use a statistically selected subset of the pattern.

The actualization may also be autogen. This is the case when the actualization results from manipulating isolated words. In the example of the derivatives pattern, one may create derivatives of a given word by substituting to each vowel or consonant the other possible vowels or consonants. For instance, starting from the word VITAMIN, one would obtain BITAMIN, CITAMIN . . . VATAMIN, VETAMIN . . . VIBAMIN, VICAMIN, etc. Autogen actualization may also be used for neologisms. For instance, one could substitute to the last three letters of SERENITY one or more letters of the alphabet, to create neologisms like SERENIS.

Last, the actualization may be endogen. This is the case when the actualization is based on the set of existing names or uses the set of existing names. Some examples of endogen actualization are now provided. One example in the case of a phonetic pattern consists in changing the first (or last) letters of all names in the set of names. For instance, the VIV—pattern could be actualized by sampling the set of existing names for those having more than three letters, with the first letters a consonant, followed by a vowel and another consonant. The three first letters of the sampled existing names could then be changed to VIV. For instance, using this endogen actualizing step, the existing names BAVARIA and RIVOLI would be changed to VIVARIA and VIVOLI. Such endogen actualization ensures that the names in the pattern will be pronounceable. In addition, this type of actualizing step provides far more results, in that it capitalizes over solutions already devised by others.

One may mix various types of actualizations, according to the pattern and/or according to the number of results. The actualizing method used in step 8 may result from the pattern selection; in other words, patterns may be associated with one or several given actualizing methods. The actualizing method may also be selected randomly, or may be selected by the user.

The output of step 8 is a list of possible names, based on the selected pattern. The number of names after step 8 may be important—e.g. for patterns such as lexemes or toponyms. The number of names provided by the actualization of the pattern is only limited by the computing time available for the method. The method could thus be carried out for any number of names provided in the actualization step. Practically speaking, it is preferable to limit the number of names output by the actualization, according to the storage capacity and computing power available for running the method. Additionally, the number of names after step 8 may be adapted dynamically, according to the number of names generating in the method, as discussed below.

After step 8, the process flows to step 10. In step 10, the list of possible names is filtered against the set of names provided in step 2. The filtering step, in the simplest embodiment of the invention, comprises checking, for each name of the list of names output at step 8, whether the said name is identically comprised in the set of names. The filtering step may be more elaborate. For instance, if the set of names is partitioned in classes, filtering may consist in checking, for each name of the list of names output at step 8, whether the said name is identically comprised in one or several classes in the set of names. One may use different or additional filtering rules. For instance, one may use analogic filtering, whereby a names is considered to be identical to another one if they differ by one letter only. Another possible rule is to ignore doubled letters.

One understands that the step of filtering and actualizing may be carried out at the same time. The use of an antibase results in that the names provided by actualizing are not comprised in the set of existing names. In this instance, filtering may not be necessary and could be done without. Even when an antibase is used, one may still provide a step of analogic filtering, or another step of filtering, e.g. for reducing the number of results displayed to the user.

At the end of step 10, there is provided a filtered list of names. The names are displayed as shown in step 12.

The names output by the process are different from those existing in the set of names. In the examples of URLs, the process provides URLs which are free for registrations. In the example of trademarks, the process provides trademarks with a high likelihood of freedom to register. In the example of company names, the process provides names which are not likely to be similar to existing companies, in the same geographical area or field of the art. Compared to prior art methods, the solution of FIG. 1 is faster and provides far more results.

As discussed above, steps 8 and 10 may be repeated or dynamically adapted according to the number of names provided. This is represented by the arrow in interrupted line on FIG. 1. For instance, if the number of names provided at the end of step 10 is too low, compared to a given number, steps 8 and 10 could be repeated. One could use a different actualization method, and/or a different filtering step. The actualization step may be adapted to provide more results and/or the filtering step may be less stringent. Both solutions results in a higher number of generated names. Similarly, if the number of generated names is too high, one may repeated steps 8 and 10 to lessen the number of generated names. Upon user's request, steps 8 and 10 may be repeated to provide alternate or additional names, with the same pattern selection. This makes it possible to provide more names to the user, without having to select again one pattern or several patterns.

There are several possible methods for allowing a user to select one of the patterns. In a first embodiment of the invention, patterns are selected by the user among a list of possible patterns. The patterns may be provided to the user as a closed list; otherwise, the user may create his own pattern; e.g. in the example of a phonetic pattern, the user may select a letter or group of letters which he wants to appear in the generated names. It is also possible to allow the user to select more than one pattern, so that the generated names will belong to more than one pattern. One may alternatively select a combination of more than one pattern, in case the generated names should belong to more than one pattern.

In a second embodiment of the invention, the selection of patterns is semi-manual and derives from brain-storming. As a result, the user is not prompted to directly select one or more patterns: the selection of pattern(s) is derived from the ideas and solutions appearing through the brain-storming session.

In a third embodiment of the invention, the selection is a semi-automatic selection, based on forms. The user is requested to fill in forms and respond to questions regarding the names that should be generated. Based on the answer to the questions, one or more patterns are selected.

In a fourth embodiment of the invention, the user is prompted to enter names which are representative of the pattern (or patterns) in which the names should be generated. When the user enters at least two names, the system searches for features common to the two names, so as to determine a pattern based on the names inputted by the user. One may search for phonetic patterns and thereafter for semantic patterns; this makes it possible, for inputted names, to select at least one pattern to which the inputted names belong. The outcome is that at least one pattern is selected. This provides an automatic section of the pattern, based on the names inputted by the user of the system. An automatic selection of the pattern may similarly be carried out based on a given set of names, even if it is not inputted by the user. For instance, the user may select a number of names already generated by the system and may wish more names like the ones already generated; in this case, the selected names may be inputted to select one or more patterns.

Other solutions may be contemplated for allowing the user to select one or more patterns.

The method of the invention may be implemented by a program running on a state of the art computer. One may use for the program the Perl language. The invention was implemented with a database of trademarks and trademark applications filed in most Western countries, with a total number of entries higher than 20 million. Each entry comprised the country, the sign used as trademark and the relevant class or classes for the trademark. The database was thus partitioned by classes. The total volume of the database was about 31 gigabytes. The machine running the program had an AMD 2000+ processor with a speed of 1.2 GHz, a hard disk drive of 40 gigabytes, a RAM of 256 Mbytes. The machine was running under a Linux Red Hat operating software. One iteration of the process—from the selection of a pattern to the generation of names—was carried out in a time ranging between 15 s and two minutes.

In another embodiment, the invention was carried out with a similar program, for all registered domain names. The set of existing names comprised more than 25 million entries. The running time for carrying out the process was similar.

These examples show that the invention may be carried out with existing software and hardware.

FIG. 2 is a schematic view of a computer system embodying the invention. The system of FIG. 2 comprises a computer server 20, on which runs a program embodying the invention. The computer comprises one or more processors, with associated RAMs for loading the program. There is provided an outside memory 22 containing the database of existing names. Input-output devices such as keyboard 24, tracking device 26 and screen 28 make it possible for a user of the system to control the operation of the computer, select patterns and the like, directly on computer server 20. In addition, computer server 20 may be accessed by remote computer clients such as computers 30 and 32. The remote access may be an access through any type of network, e.g. through an IP-protocol network 34 such as the Internet or an Intranet, or network using other protocols. Allowing users to connect remotely to computer server 20 makes it possible to generate names based on requests entered by users from distant computers. The method of the invention may thus be run on the Internet for helping users to generate names. The method could for instance be used for helping users in selecting trademarks with a high likelihood of freedom to operate, in selecting domain names, etc. The method may also be completed by a step of on-line registration of selected names. For instance, in the case of domain names, users may be prompted to register on-line one or more selected names. In the example of trademarks, users may be prompted to provide on-line information necessary for the filing of a trademark application. Due to the filtering step or to the use of an antibase, the names generated according to the invention are generally free for registration.

The invention is not limited to the examples and embodiments disclosed above. It may be applied for generating names other than domain names, trademarks or company names; patterns other than the ones exemplified may be used. Filtering methods more elaborate than the ones discussed in reference to step 10 fall within the scope of the invention, as defined by the appended claims.

1. A computer-implemented method for generating names, comprising the steps of
storing a set of patterns comprising at least one pattern other than concatenation, each pattern comprising names having a common feature;
providing a set of existing names;
selecting one pattern of the set of patterns;
actualizing the selected pattern to provide a list of possible names;
filtering the list of possible names against the set of existing names.

2. The method of claim 1, wherein the step of actualizing comprises
providing a dictionary and
extracting names out of the dictionary, according to the selected pattern.

3. The method of claim 1, wherein the step of actualizing comprises
extracting names out of the set of names for said selected pattern and
amending the extracted names.

4. The method of claim 3, wherein the step of amending comprises changing at least one letter of an extracted name.

5. The method of claim 1, wherein the step of selecting one pattern is carried out by a user.

6. The method of claim 1, wherein the step of selecting one pattern comprises
providing at least two names;
determining a feature common to said at least two names;
determining a pattern in the set comprising names having said determined feature.

7. The method of claim 1, wherein the step of filtering comprises deleting from the list of possible names names comprised in the set.

8. The method of claim 1, wherein the step of filtering comprises deleting from the list of possible names names similar to those comprised in the set of names.

9. A computer-implemented method for generating names, comprising the steps of
storing a set of patterns, each pattern comprising names having a common feature;
providing a set of existing names partitioned into classes;
selecting one class in the set of existing names;
selecting one pattern of the set of patterns comprising at least one pattern other than concatenation;
actualizing the selected pattern to provide a list of possible names;
the step of actualizing comprising searching for names having the common feature of the selected pattern among the names contained in the set of existing names and not belonging to the selected class.

10. The method of claim 9, further comprising a step of filtering the list of possible names.

11. The method of claim 10, wherein the step of filtering comprises deleting from the list of possible names names similar to those comprised in the selected class.

12. The method of claim 9, wherein the step of selecting one pattern is carried out by a user.

13. The method of claim 9, wherein the step of selecting one pattern comprises
providing at least two names;
determining a feature common to said at least two names;
determining a pattern in the set comprising names having said determined feature.

14. A computer program, comprising
a database of patterns comprising at least one pattern other than concatenation, each pattern comprising names having a common feature;
a database of existing names partitioned into classes;
a routine for allowing a user to select one class in the set of existing names;
a routine for allowing a user to select one pattern of the set of patterns;
a routine for actualizing the selected pattern to provide a list of possible names;
the routine for actualizing comprising a routine for searching for names having the common feature of the selected pattern among the names contained in the set of existing names and not belonging to the selected class.

15. The program of claim 14, further comprising a routine for filtering the list of possible names.

16. The program of claim 15, further comprising a routine for filtering the list of possible names by deleting from the list of possible names names similar to those comprised in the selected class.
